(19) United States
(12) Patent Application Publication
(10) Pub. No.: US 2015/0042569 A1
(43) Pub. Date: Feb. 12, 2015

(54) Keyboard for Inputting Multiple Languages Using Detachable Keypad

(71) Applicant: Jin Won Choi, Changwon-si (KR)

(72) Inventor: Jin Won Choi, Changwon-si (KR)

(21) Appl. No.: 14/385,567

(22) PCT Filed: Nov. 5, 2012
(86) PCT No.: PCT/KR2012/009219

§ 371 Date: Sep. 16, 2014

(30) Foreign Application Priority Data
Mar. 16, 2012 (KR) 10-2012-0027338

(51) Int. Cl. G06F 3/02; H01H 3/12

(52) U.S. Cl. CPC G06F 3/0219; H01H 3/12; G06F 3/0202
USPC 345/171

(57) ABSTRACT

The present invention relates to a keyboard for inputting multiple languages using a detachable keypad. More particularly, the present invention includes: a base board; rows of a plurality of key caps that are disposed on the base board; and a plurality of moving mechanism members that connect the key caps to the base board and enable the key caps to vertically move relative to the base board. Each key cap is divided into an opaque portion and a transparent portion, and characters are disposed on the upper surface thereof. The insertion-type keyboard for inputting multiple languages according to the present invention comprises an insertion member that is provided such that a character can be seen by a user through the transparent portion, and a space part in which the insertion member is accommodated between the base board and the transparent portion in the direction in which the rows of key caps are arranged.

### TECHNICAL FIELD

The present invention relates to a keyboard for inputting multiple languages using a detachable keypad and, more particularly, to an insertion type keyboard for inputting multiple languages, including: a base board; rows of a plurality of key caps that are disposed on the base board; and a plurality of moving mechanism members that connect the key caps to the base board and enable the key caps to vertically move with respect to the base board, wherein the key caps each are divided into an opaque portion and a transparent portion, and comprise an insertion member having characters positioned on an upper surface thereof and allowing the characters to be visible to a user through the transparent portion, and a space part allowing the insertion member to be accommodated between the base board and the transparent portions in a row direction of the key caps.

### BACKGROUND

Keyboards, input devices of computers, may be classified as a mechanical, membrane, qwerty-type keyboard, and a touch screen and used to perform inputting in computers or mobile devices. Various languages exist throughout the world, and multiple applications, menus of system software, graphic user interfaces (GUIs), and speed keys, and the like, are used to input special characters in personal computers (PCs) or mobile devices.

Also, various speed keys are provided for various computer games. However, conventional keyboards have a limitation in that they can only display one or two languages, requiring the role of helping input by marking various characters and symbols changing on a single keyboard.

As a solution, Korean Patent Registration No. 20-0289746 entitled a “Multi-language Window Automatic Control Device using Touch Keyboard” will be referred to as a related art keyboard using a touch screen.

This patent has shortcomings in that coordinate values should be designated for languages of each country in designing a screen, country language recognition information and display information corresponding to the coordinate values should be designed, a new touch keyboard including a back screen, which is not general nor familiar, should be created, and an extra space is required to store multi-language window data. In addition, since characters are selected upon receiving a language conversion key input through a touch keyboard, an extra storage device for character conversion is required so that when a character is selected, a screen may be converted into a window screen of a corresponding language. This may be utilized in a place such as an airport where foreigners come and go, but a display time may vary according to performance of storage devices and a global use is limited.

In addition, the foregoing patent is not applicable to a heterogeneous device, or the like, and since multi-language character strings are selectively displayed, a corresponding language is searched though several stages and displayed. Also, a character display unit is provided in a lower back screen and a contact part in which a touch is sensed based on a change in capacitance Cs is provided above the back screen, causing a high error rate of touch sensing, and a central processing unit for controlling a back screen that receives a multi-language driving control signal and converts it into a corresponding language and a monitor receiving a control signal and displaying a corresponding language should be required.

The present invention proposes a method for simply selecting characters, rather than a scheme of displaying character selection using such a complicated structure.

### SUMMARY

An aspect of the present disclosure provides a keyboard supporting multiple languages allowing users to replace and use a keypad as desired by using printed characters on one side and transparent keys and a detachable keypad on the other side.

In particular, three or four detachable keypads are provided, or a structure in which three or four lines can be replaced simultaneously at a time with a single frame is provided.

Also, the transparent portion may serve as a magnifier to optically magnify a semi-transparent key, whereby a detachable keypad can be minimized to contribute to reduce a size of a space in which the detachable keypad is inserted, providing a configuration considering structures of a circuit or a grounding unit of the keyboard.

According to the present invention, the keyboard supporting multiple languages allowing users to replace and use a keypad as desired by using the detachable keypad having a transparent portion can be provided.

According to an aspect of the present invention, there is provided a keyboard including a base board; rows of a plurality of key caps positioned on the base board; and a plurality of moving mechanism members connecting the key caps to the base board and enabling the key caps to vertically move with respect to the base board.

In the keyboard, the key caps each are divided into an opaque portion and a transparent portion, and comprise an insertion member having characters positioned on an upper surface thereof and allowing the characters to be visible to a user through the transparent portion, and a space part allowing the insertion member to be accommodated between the base board and the transparent portions in a row direction of the key caps.

In particular, each of the transparent portions includes a magnifier therein to magnify the characters in size so as to be visible to a user.

Also, according to another aspect of the present invention, there is provided a keyboard including a base board; rows of a plurality of key caps positioned on the base board; and a plurality of moving mechanism members connecting the key caps to the base board and enabling the key caps to vertically move with respect to the base board.

In the keyboard, the key caps each are divided into an opaque portion and a transparent portion, and comprise an insertion member having characters positioned on one surface thereof and positioned to allow the characters to face lateral surfaces of the transparent portions in the row direction of the key caps, and a reflective member positioned below the transparent portions and sloped to allow an image of the characters coming from the lateral surfaces of the transparent portions to go to upper surfaces of the transparent portions.

### BRIEF DESCRIPTION OF THE DRAWINGS

FIG. 1 is a perspective view of a general key board.

FIG. 2 is an exploded perspective view illustrating a configuration and an operating mechanism of the general keyboard.

FIGS. 3 through 8 are views illustrating a configuration of a keyboard according to the present invention.

### DETAILED DESCRIPTION

In describing the present invention, if a detailed explanation for a related known function or construction is considered to unnecessarily divert the gist of the present invention, such explanation will be omitted but would be understood by those skilled in the art. Also, similar reference numerals are used for the similar parts throughout the specification. Also, it should be noted that like reference numerals already used to denote like elements in other figures are used for elements wherever possible.

Moreover, the terms used henceforth have been defined in consideration of the functions of the present invention, and may be altered according to the intent of a user or operator, or conventional practice. Therefore, the terms should be defined on the basis of the entire content of this specification.

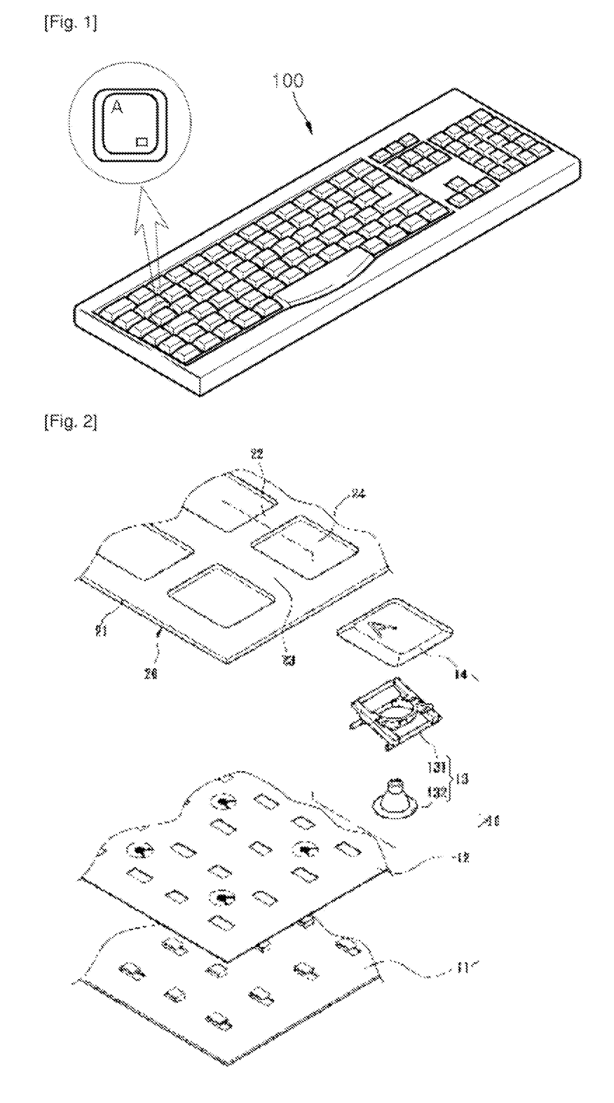

FIG. 1 is a perspective view of a general keyboard, and FIG. 2 is a view illustrating a mechanism of a general keyboard.

A keyboard unit 10 includes a base board 11 and rows of a plurality of key caps 14 positioned on the base board 11. The key caps 14 in neighboring rows are spaced apart by a first gap 15, and neighboring key caps 14 in each row are spaced apart by a second gap 16. The key caps 14 and the base board 11 are connected by a plurality of moving mechanisms 13. Each of the moving mechanisms 13 includes a movable member 131 connecting the key cap 14 to the base board 11 and an elastic member 132 supporting the key cap 14 to provide restoring force to the key cap 14. The key cap 14 may be pressed and may vertically move with respect to the base board 11 through the moving mechanism 13. Also, the keyboard unit 10 further includes a circuit board 12 interposed between the key caps 14 and the base board 11 to generate command signals based on a compression and touch of the elastic member 132 while the key caps 14 are moving vertically.

Such an operating mechanism may be used in the present invention and a “moving mechanism member 60” as described hereinafter may be considered to be identical to the moving mechanism of FIG. 2.

The keyboard for inputting multiple languages using a detachable keypad according to the present invention will be described in detail.

The present invention relates to a key board including a base board 50; rows of a plurality of key caps 31 positioned on the base board 50; and a plurality of moving mechanism members 60 connecting the key caps 31 to the base board 50 and enabling the key caps 31 to vertically move with respect to the base board 50. This is the same as described above.

However, major characteristics of the present invention lie in that each of the key caps 31 are divided into an opaque portion 32 and a transparent portion 33, and here, general Hangul and English keypads are permanently marked on the opaque portions and keypads including various languages such as Japanese, Chinese, German, and French languages can be replaced through the transparent portions 33.

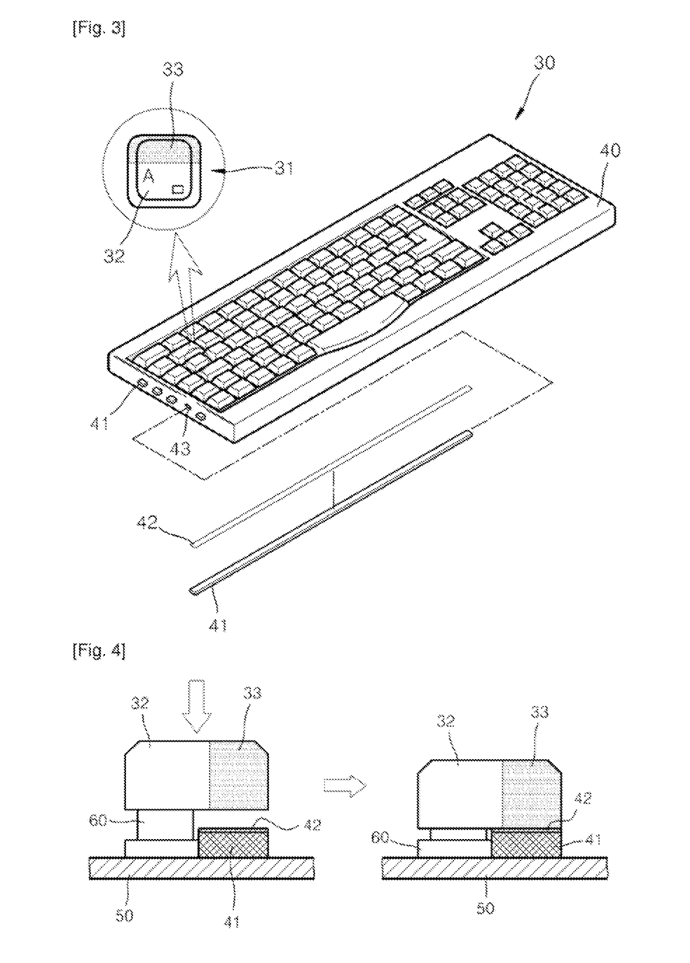

To this end, referring to FIG. 3, the base board 50, the key caps 31, and the moving mechanism members 60 are provided in a case unit 40.

In the present invention, holes are formed on the side of the case unit 40, and an accommodation space is provided in a row direction of the key caps 31 through the holes and the insertion member 41 with character marks 42 of various languages attached thereto is provided in the accommodation space. Here, a character may be marked on the insertion member 41. The character marks of the insertion member 41 inserted into the accommodation space may be visible to a user through the transparent portions 33 of the key caps 31.

When displaying languages other than Hangul and English using a computer, the user may replace the insertion member 41 on which characters previously set for each of the key caps within the computer to easily recognize the characters corresponding to the key caps, respectively.

In the related art, to this end, a key skin or a sticker is added to upper portions of the key caps, which, however, causes user inconvenience in a replacing operation.

In the present disclosure, the “rows of key caps” refers to a combination of key caps arranged in a horizontal direction in alignment. “One direction of key caps” refers to a direction of key caps in the horizontal direction in alignment.

FIG. 4 illustrates a keyboard according to an embodiment of the present invention. There are illustrated the insertion member 41 having characters positioned on an upper surface thereof and allowing the characters to be visible to the user through the transparent portion 33 and a space part in which the insertion member 41 is accommodated between the base board 50 and the transparent portion 33 in a raw direction of the key caps 31.

As illustrated in FIG. 4, the moving mechanism member 60 is not positioned between the transparent portion 33 and the base board 50. Namely, in the present invention, the moving mechanism member 60 is formed as narrow as possible so as to be positioned to be limited to the opaque portion 32.

The insertion member 41 is insertedly positioned in the space part below the transparent portion 33. Characters corresponding to the key caps 31 are displayed on the insertion member 41 through the transparent portions 33 when the insertion member 41 is completely inserted. The user may recognize characters seen through the transparent portions 33 and press a key cap corresponding to a desired character to input the character.

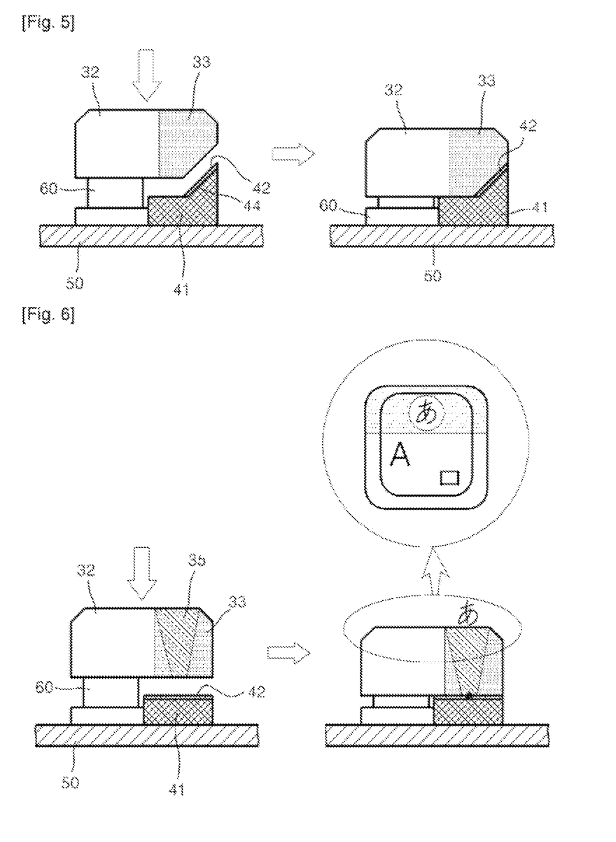

FIG. 5 illustrates another embodiment of the present invention.

Another embodiment of the present invention is a modified example in terms of the structure of the insertion member 41. The insertion member 41 has a sloped structures allowing characters marked on the key caps to be easily visible to the user.

Namely, the insertion member 41 has a sloped surface 44 toward the user, and characters are marked on the sloped surface 44. Also, the transparent portions of the key caps has a sloped surface 34 in contact to correspond to such a configuration. An operational principle is the same as that of the former embodiment described above, and thus, a detailed description thereof will be omitted.

FIG. 6 is a view illustrating a configuration in which a magnifier 35 is inserted into an interior of the transparent portion 33 to enhance user convenience. The transparent portion 33 may include the magnifier 35 to magnify a character in size so as to be visible to the user. The magnifier 35 may have a convex lens shape, or the like.

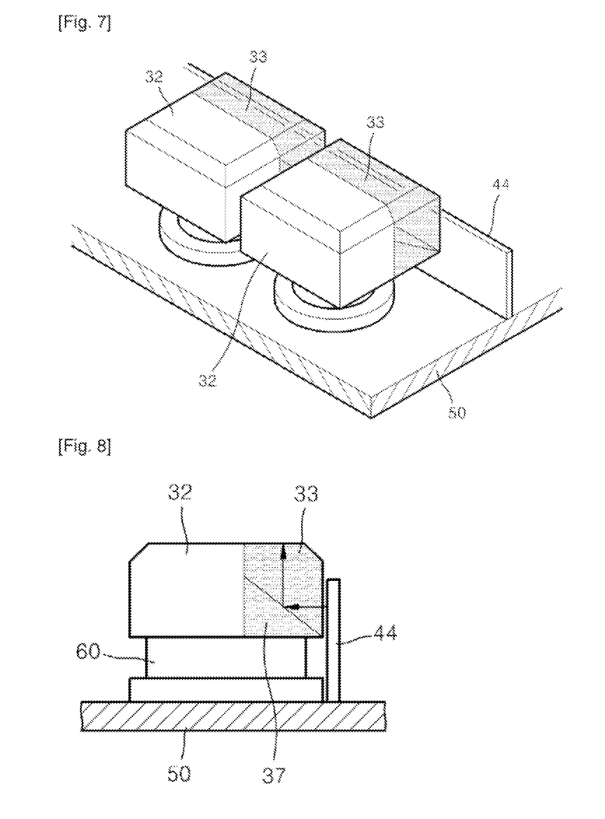

FIGS. 7 and 8 illustrate another embodiment of the present invention.

Another embodiment of the present invention provides a keyboard including a base board 50; rows of a plurality of key caps 31 positioned on the base board 50; and a plurality of moving mechanism members 60 connecting the key caps 31 to the base board 50 and enabling the key caps 31 to vertically move with respect to the base board 50, wherein the key caps 31 each is divided into an opaque portion 32 and a transparent portion 33, and comprise an insertion member 44 having characters positioned on one surface thereof and positioned to allow the characters to face lateral surfaces of the transparent portions 33, and a reflective member 37 positioned below the transparent portions 33 and sloped to allow an image of the characters coming from the lateral surfaces of the transparent portions 33 to go to upper surfaces of the transparent portions 33.

As illustrated in FIG. 7, the insertion member 44 is positioned on the side of the key caps, rather than being positioned below the key caps. However, in order to allow the user to recognize character written on the insertion members 44, an extra member for converting a direction of an image of characters passing through the transparent 33 is required.

To this end, the reflective member 37 for converting the image of characters by 90 degrees is further provided at an inner side of the transparent portions 33. The reflective member 37 may be, for example, a mirror, or the like.

In this manner, characters of a foreign language set for a computer system in advance are marked on the insertion member, the user may replace the keypad according to a language selected by the computer system, thereby providing user convenience allowing users to easily recognize characters corresponding to key caps.

As the embodiments may be implemented in several forms without departing from the characteristics thereof, it should also be understood that the above-described embodiments are not limited by any of the details of the foregoing description, unless otherwise specified, but rather should be construed broadly within its scope as defined in the appended claims. Therefore, various changes and modifications that fall within the scope of the claims, or equivalents of such scope are therefore intended to be embraced by the appended claims.

1-3. (canceled)

4. An insertion-type keyboard for inputting multiple languages, the keyboard comprising:
a base board;
rows of a plurality of key caps positioned on the base board; and
a plurality of moving mechanism members connecting the key caps to the base board and enabling the key caps to vertically move with respect to the base board,
wherein the key caps each are divided into an opaque portion and a transparent portion, and comprise an insertion member having characters positioned on an upper surface thereof and allowing the characters to be visible to a user through the transparent portions, and a space part allowing the insertion member to be accommodated between the base board and the transparent portions in a row direction of the key caps.

5. The insertion-type keyboard of claim 4, wherein each of the transparent portions includes a magnifier to magnify the characters in size so as to be visible to a user.

6. An insertion-type keyboard for inputting multiple languages, the keyboard comprising:
a base board;
rows of a plurality of key caps positioned on the base board; and
a plurality of moving mechanism members connecting the key caps to the base board and enabling the key caps to vertically move with respect to the base board.
wherein the key caps each are divided into an opaque portion and a transparent portion, and comprise an insertion member having characters positioned on one surface thereof and positioned to allow the characters to face lateral surfaces of the transparent portions in the row direction of the key caps, and a reflective member positioned below the transparent portions and sloped to allow an image of the characters coming from the lateral surfaces of the transparent portions to go to upper surfaces of the transparent portions.
